(19) United States
(12) Patent Application Publication
(10) Pub. No.: US 2026/0017834 A1
(43) Pub. Date: Jan. 15, 2026

(54) SIGNALING OF INSTANCING FOR VOLUMETRIC VIDEO

(71) Applicant: Nokia Technologies Oy, Espoo (FI)

(72) Inventors: Lauri Aleksi ILOLA, Tampere (FI); Lukasz KONDRAD, Munich (DE); Patrice RONDAO ALFACE, Antwerp (BE)

(21) Appl. No.: 19/264,308

(22) Filed: Jul. 9, 2025

Related U.S. Application Data
(60) Provisional application No. 63/669,813, filed on Jul. 11, 2024.

(51) Int. Cl. G06T 9/00; H04N 19/70

(52) U.S. Cl. CPC G06T 9/001; H04N 19/70

(57) ABSTRACT

An encoder obtains a mesh representation of volumetric video, and determines the mesh representation is to be instanced and how to instance the mesh representation. The encoder creates signaling information related to instanced drawing of the mesh representation. The encoder stores the signaling information related to the instanced drawing in or along with the mesh representation. A decoder obtains a mesh representation of volumetric video from a bitstream and signaling information related to instanced drawing in or along the mesh representation in the bitstream. The decoder interprets the signaling information, and acts upon the interpreted signaling information.

### TECHNICAL FIELD

Examples of embodiments herein relate generally to media encoding and decoding and, more specifically, relate to volumetric video encoding and decoding using meshes.

### BACKGROUND

There are many different techniques used to encode and decode video, and these techniques depend on how the video (e.g., and other elements including sound) is captured. For instance, volumetric video refers to a type of video content that captures a three-dimensional (3D) scene or environment from multiple angles, creating a more immersive and interactive viewing experience.

Furthermore, once the volumetric video is captured, there are multiple ways to represent the volumetric video. One way is referred to as Video-based Dynamic Mesh Coding (V-DMC), which is a compression technique used to efficiently encode and transmit volumetric video data, which is particularly useful for virtual reality (VR), augmented reality (AR), and mixed reality (MR) applications.

In traditional mesh coding, a 3D model or scene is represented as a static mesh, where each vertex has a fixed position. In contrast, V-DMC uses video-based techniques to encode the dynamic motion of objects within a 3D scene. This involves the following: 1) Object tracking algorithms are used to monitor the movement and deformation of objects in the scene; 2) The tracked data is then used to warp the underlying mesh, creating a new, deformed mesh that accurately represents the object's current position and shape; and 3) The warped mesh is then encoded using video compression techniques, such as H.264 or H.265.

Benefits include efficient compression, as V-DMC takes advantage of the temporal coherence in dynamic scenes, allowing for more efficient compression ratios compared to traditional static mesh coding. Furthermore, by accurately capturing object motion and deformation, VDMC enables more realistic and immersive experiences in VR/AR/MR applications. Additionally, the compressed mesh data can be rendered at different levels of detail or complexity, allowing for trade-offs between computational requirements and visual quality.

The volumetric video compressed using V-DMC is placed into a bitstream, which may also include other information. In particular, Supplemental Enhancement Information (SEI) may be used, which refers to a set of auxiliary data that provides additional information about the dynamic mesh, such as vertex weights, edge priorities, and object boundaries.

While there are benefits to using volumetric video including V-DMC and corresponding information such as SEI, improvements could be made.

### BRIEF SUMMARY

This section is intended to include examples and is not intended to be limiting.

In an exemplary embodiment, a method is disclosed that includes obtaining a mesh representation of volumetric video; determining the mesh representation is to be instanced and how to instance the mesh representation; creating signaling information related to instanced drawing of the mesh representation; and storing the signaling information related to the instanced drawing in or along with the mesh representation.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: obtaining a mesh representation of volumetric video; determining the mesh representation is to be instanced and how to instance the mesh representation; creating signaling information related to instanced drawing of the mesh representation; and storing the signaling information related to the instanced drawing in or along with the mesh representation.

An exemplary computer program product includes a computer-readable storage medium bearing instructions that, when executed by an apparatus, cause the apparatus to perform at least the following: obtaining a mesh representation of volumetric video; determining the mesh representation is to be instanced and how to instance the mesh representation; creating signaling information related to instanced drawing of the mesh representation; and storing the signaling information related to the instanced drawing in or along with the mesh representation.

In another exemplary embodiment, an apparatus comprises means for: obtaining a mesh representation of volumetric video; determining the mesh representation is to be instanced and how to instance the mesh representation; creating signaling information related to instanced drawing of the mesh representation; and storing the signaling information related to the instanced drawing in or along with the mesh representation.

In an exemplary embodiment, a method is disclosed that includes obtaining a mesh representation of volumetric video from a bitstream and signaling information related to instanced drawing in or along the mesh representation in the bitstream; interpreting the signaling information; and acting upon the interpreted signaling information.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: obtaining a mesh representation of volumetric video from a bitstream and signaling information related to instanced drawing in or along the mesh representation in the bitstream; interpreting the signaling information; and acting upon the interpreted signaling information.

An exemplary computer program product includes a computer-readable storage medium bearing instructions that, when executed by an apparatus, cause the apparatus to perform at least the following: obtaining a mesh representation of volumetric video from a bitstream and signaling information related to instanced drawing in or along the mesh representation in the bitstream; interpreting the signaling information; and acting upon the interpreted signaling information.

In another exemplary embodiment, an apparatus comprises means for: obtaining a mesh representation of volumetric video from a bitstream and signaling information related to instanced drawing in or along the mesh representation in the bitstream; interpreting the signaling information; and acting upon the interpreted signaling information.

### BRIEF DESCRIPTION OF THE DRAWINGS

The accompanying drawings use reference numerals, where the same reference numerals may be used to refer to like parts throughout, but parts having the same reference numeral can differ in operation and components. In the attached drawings:

FIG. 1 is a block diagram illustrating a system in accordance with an example;

FIGS. 1A and 1B are block diagrams illustrating volumetric media conversion at (FIG. 1A) an encoder and reconstruction at (FIG. 1B) a decoder, where volumetric video is converted to a series of 2D (two dimensional) representations: base mesh, geometry, and attributes, and where additional atlas information is also included in the bitstream to enable inverse reconstruction;

FIG. 2 is a block diagram illustrating a V-DMC delivery stack;

FIG. 3 is a block diagram of a flowchart performed by an encoder for signaling of instancing for volumetric video;

FIG. 4 is a block diagram of a flowchart performed by a decoder for signaling of instancing for volumetric video; and

FIG. 5 is an example of a block diagram of an apparatus suitable for implementing any of the encoders or decoders described herein.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the examples.

When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that capital and lowercase words or phrases are considered to be the same herein. For instance, the words Slice and slice are the same, as are the phrases Network Repository Function and network repository function.

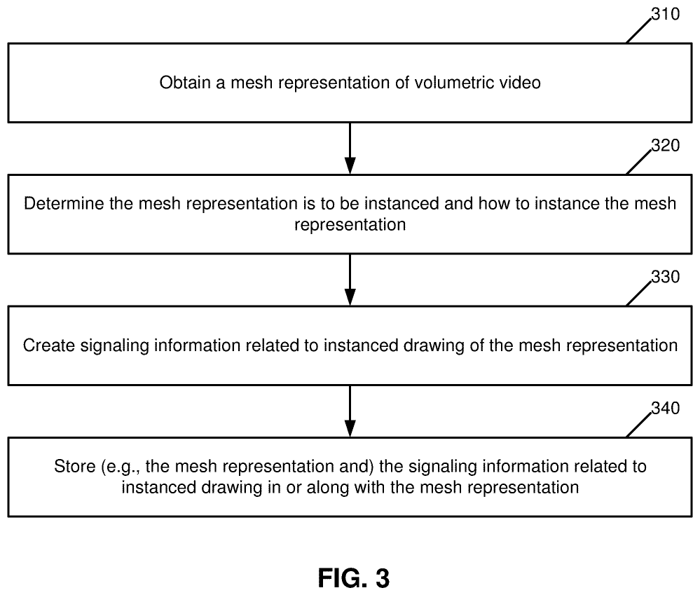

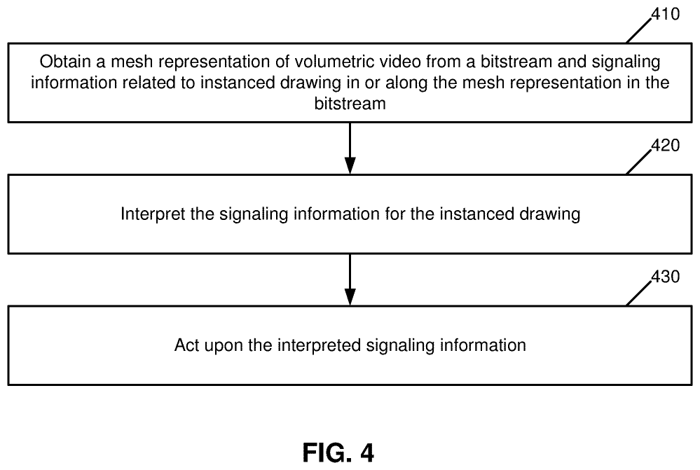

Any flow diagram (such as FIGS. 3 and 4) or signaling diagram herein is considered to be a logic flow diagram, and illustrates the operation of an exemplary method, results of execution of computer program instructions embodied on a computer readable memory, and/or functions performed by logic implemented in circuitry. For methods, flow diagrams, and signaling diagrams, the orders of method steps, blocks in the flow, or signaling are not critical and instead are examples.

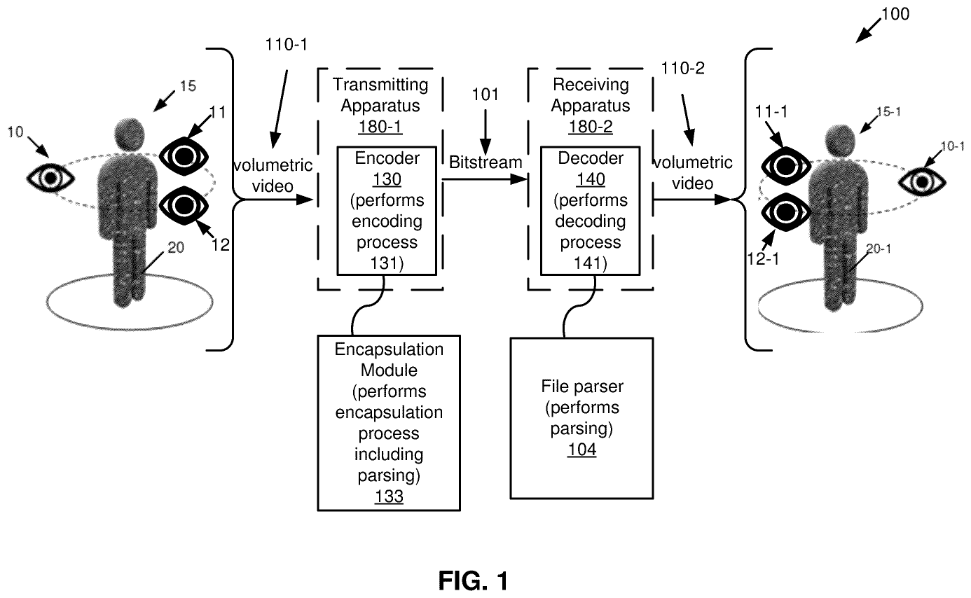

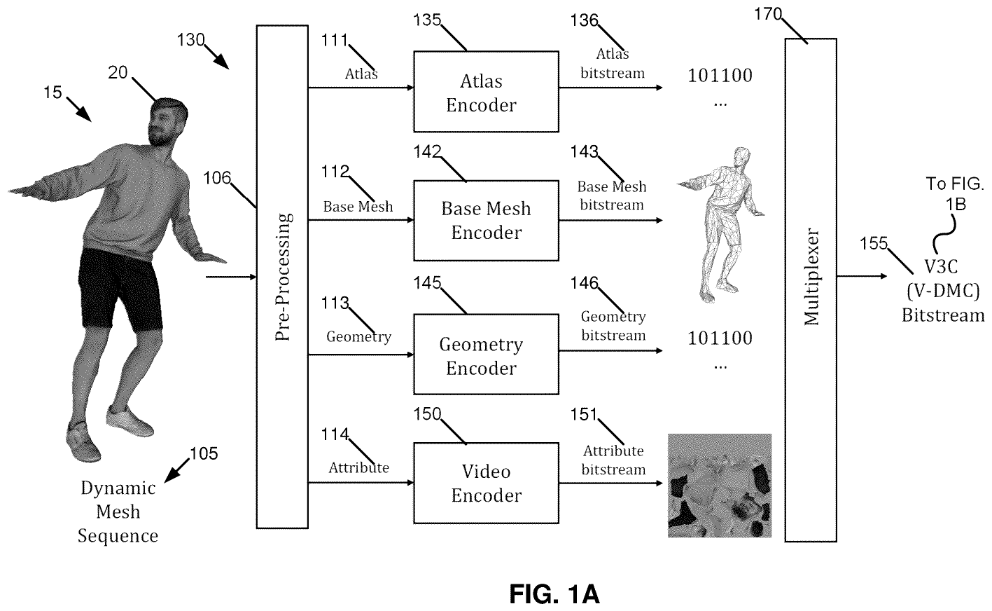

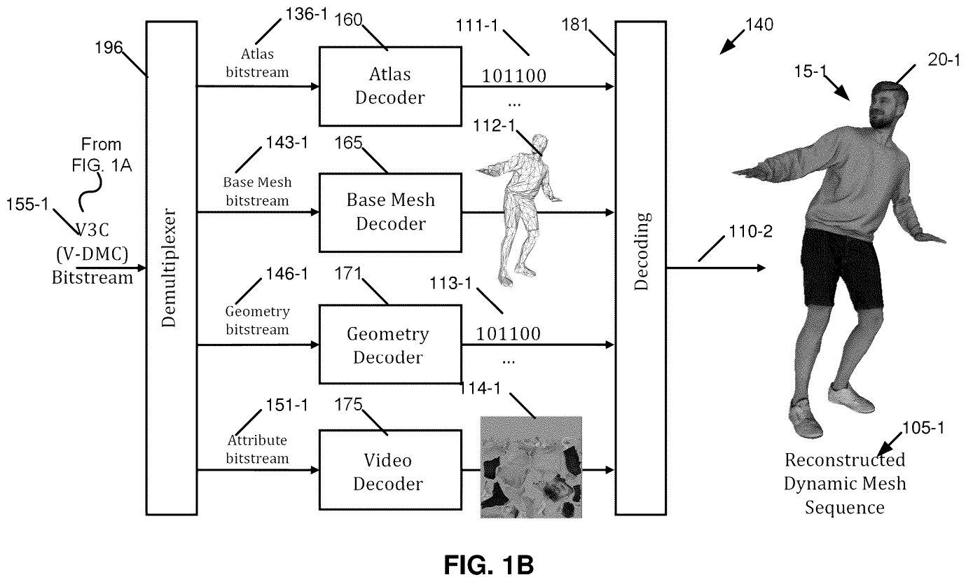

Technical context is now provided for technical areas related to the understanding of the examples. Referring to FIG. 1, this figure is a block diagram illustrating a system 100 in accordance with an example. In the example, the encoder 130 is used to encode volumetric video 110-1 from the scene 15, and the encoder 130 is implemented in a transmitting apparatus 180-1. In this example, there is a capture of input video at viewpoints 10, 11, and 12 of a scene 15, which includes a human being 20. The encoder 130 uses the encapsulation module 133, which forms file structures, and performs an encapsulation process, including parsing, or any other elements to encapsulate data, and which forms part of the bitstream 101 signaled by the encoder 130. The encoder 130 produces a bitstream 101, using the encoding process 131 on the input volumetric video 110-1, that is received by the receiving apparatus 180-2. The receiving apparatus 180-2 implements a decoder 140, which performs a decoding process 141. The decoder 140 uses the file parser 104, which performs parsing to parse the file structures that are received from the bitstream 101. The decoder 140, using the decoding process 141 (and the file parsing) on the bitstream 101, forms the output volumetric video 110-2 (as a representation of the input volumetric video 110-1) for the scene 15-1, and the receiving apparatus 180-2 would present this to the user, e.g., via a smartphone, television, or projector among many other options. The scene 15-1 may be represented using viewpoints 10-1, 11-1, and 12-1 and contains representations of at least a human being 20-1. It is noted that the encapsulation module 133 can be split from the encoder 130, and the file parser 104 can be split from the decoder 140 if desired. It is also noted that the encoder 130 need not perform or may perform encryption, and similarly the decoder 140 may not perform or may perform decryption. The encoder 130 and decoder 140 may be applied to multiple coding standards.

For instance, embodiments herein may concern volumetric video capture, coding, transmission, and decoding. FIGS. 1A and 1B are block diagrams illustrating volumetric media conversion at (FIG. 1A) an encoder 130 and reconstruction at (FIG. 1B) a decoder 140, where the volumetric video 110-1 is converted to a series of 2D (two dimensional) representations: geometry, and attributes, and base mesh is a simplified (low resolution) mesh approximation of the original volumetric video, and where additional atlas information is also included in the bitstream to enable inverse reconstruction.

In the example of FIG. 1A, a V-DMC encoder 130 is illustrated where there is a capture of volumetric video 110-1, using a dynamic mesh sequence 105, of a scene 15, which includes a human being 20. The dynamic mesh sequence 105 is operated on by the pre-processing component 106. There is first a conversion of such media from their corresponding 3D representation to multiple 2D representations, also referred to as V3C (Visual Volumetric Video-based Coding) components, before coding such information. The pre-processing component 106 converts 3D to 2D representations in streams of V3C components: geometry component 113; and attribute component 114. That is, such representations include the geometry, and attribute components. The pre-processing simplifies volumetric video representation and creates base mesh component 112. The base mesh component 112 can provide a V3C decoder (as in FIG. 1B) a simplified (e.g., low resolution) mesh approximation of the original volumetric video and is operated on by a base mesh encoder 142 to form a base mesh bitstream 143. The geometry component 113 contains information about the precise location, displacement of 3D data in space, and is operated on by the geometry encoder 145 to form a geometry bitstream 146. Meanwhile, the attribute component 114 can provide additional properties, e.g., color, or material information, of such 3D data, and is operated on by the video encoder 150 to form an attribute bitstream 151. Additional atlas information 111 is also included to enable inverse reconstruction, and the atlas encoder 135 forms an atlas bitstream 136. The multiplexer 170 accepts as input the streams 136, 143, 146, and 151, which are combined to become V3C bitstream 155 (as one version of bitstream 101).

FIG. 1B illustrates a V-DMC decoder 140, which performs the reverse of many of the operations of FIG. 1A. The V3C bitstream 155-1 (e.g., in case there are errors in the bitstream 155) is split by demultiplexer 196 into its constituent component streams: atlas bitstream 136-1; base mesh bitstream 143-1; geometry bitstream 146-1; and attribute bitstream 151-1. The atlas decoder 160 forms atlas component 111-1; the base mesh decoder 165 forms the base mesh component 112-1; the geometry decoder 171 forms the geometry component 113-1; and the video decoder 175 forms the attribute component 114-1. The decoding block 181 reconstructs the volumetric video 110-2 to reproduce a version of the volumetric video, using the reconstructed dynamic mesh sequence 105-1, of the scene 15-1, which includes a human being 20-1.

The examples of FIGS. 1A and 1B are one example of many ways to capture and represent a volumetric frame. The format used to capture and represent a volumetric frame depends on the processing to be performed on the frame, and the target application using the frame. Some exemplary representations are listed below.
1) A volumetric frame can be represented as a point cloud. A point cloud is a set of unstructured points in 3D (three-dimensional) space, where each point is characterized by its position in a 3D coordinate system (e.g., Euclidean), and some corresponding attributes (e.g., color information provided as RGBA value, or normal vectors).
2) A volumetric frame can be represented as images, with or without depth, captured from multiple viewpoints 10, 11, 12 in 3D space. In other words, it can be represented by one or more view frames (where a view is a projection of a volumetric scene onto a plane (the camera plane) using a real or virtual camera with known/computed extrinsics and intrinsics). Each view may be represented by a number of components (e.g., geometry, color, transparency, and occupancy picture), which may be part of the geometry picture or represented separately.
3) A volumetric frame can be represented as a mesh. Mesh is a collection of points, called vertices, and connectivity information between vertices, called edges. Vertices along with edges form faces. The combination of vertices, edges and faces can uniquely approximate shapes of objects.

Depending on the capture, a volumetric frame can provide viewers the ability to navigate a scene with six degrees of freedom, i.e., both translational and rotational movement of their viewing pose (which includes yaw, pitch, and role). The data to be coded for a volumetric frame can also be significant, as a volumetric frame can contain many objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression.

Visual Volumetric Video-base Coding (V3C)—ISO/IEC 23090-5-is described now. ISO/IEC 23090-5 specifies the syntax, semantics, and process for coding volumetric video. The specified syntax is designed to be generic so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame.

V3C compress a volumetric frame by projecting the 3D geometry and related attributes into a collection of 2D images along with additional associated metadata. The projected 2D images can then be coded using 2D video and image coding technologies, for example ISO/IEC 14496-10 (H.264/AVC, advanced video coding) and ISO/IEC 23008-2 (H.265/HEVC, v). The metadata can be coded with technologies specified in specification such as ISO/IEC 23090-5. The coded images and the associated metadata can be stored or transmitted to a client that can decode and render the 3D volumetric frame.

Two applications of V3C (ISO/IEC 23090-5) have been defined, V-PCC (Video-based point cloud compression) (ISO/IEC 23090-5) and MIV (MPEG immersive video, where MPEG is moving picture experts group) (ISO/IEC 23090-12). MIV and V-PCC use number of V3C syntax elements with a slightly modified semantics. An example on how the generic syntax element can be differently interpreted by the application is pdu_projection_id.
1) In case of V-PCC, the syntax element pdu_projection_id specifies the index of the projection plane for the patch. There can be 6 or 18 projection planes in V-PCC, and they are implicit, i.e., pre-determined.
2) In case of MIV, pdu_projection_id corresponds to a view ID (identification), i.e., identifies which view the patch originated from. View IDs and their related information is explicitly provided in MIV view parameters list and may be tailored for each content.

The MPEG 3DG (ISO SC29 WG7) group has started work on a third application of V3C—the mesh compression. It is also envisaged that mesh coding will re-use V3C syntax as much as possible and can also slightly modify the semantics.

To differentiate between applications of V3C bitstream, that allow a client to properly interpret the decoded data, V3C uses the ptl_profile_toolset_idc parameter.

V3C introduces a concept of a map, i.e., an attribute map or a geometry map. Attribute map is an attribute frame containing attribute patch information projected at a particular depth indicated by the corresponding geometry map. Where geometry frame containing geometry patch information projected at a particular depth. Maps can be used to store multiple layers of surface data, resulting in denser point clouds in case of V-PCC.

Another topic is V3C—V3C bitstream. A V3C bitstream is a sequence of bits that forms the representation of coded volumetric frames and the associated data making one or more coded V3C sequences (CVSs). CVS is a sequence of bits identified and separated by appropriate delimiters, and is required to start with a VPS (V3C parameter set), includes a V3C unit, and contains one or more V3C units with atlas sub-bitstream or video sub-bitstream. Video sub-bitstreams and atlas sub-bitstreams can be referred to as V3C sub-bitstreams. Which V3C sub-bitstream a V3C unit contains and how to interpret it is identified by a V3C unit header in conjunction with VPS information.

V3C bitstream can be stored according to Annex C of ISO/IEC 23090-5 which specifies syntax and semantics of a sample stream format to be used by applications that deliver some or all of the V3C unit stream as an ordered stream of bytes or bits within which the locations of V3C unit boundaries need to be identifiable from patterns in the data.

In a V3C bitstream, attribute maps and corresponding geometry maps are identified by vuh_map_index syntax element in a V3C unit header. This syntax element indicates the map index of the current geometry or attribute stream. The number of maps in V3C bitstream is signaled for each atlas by vps_map_count_minus1 syntax element in V3C parameter set. In the current version of the specification the number of maps indicated by vps_map_count_minus1 tells how many maps there are of geometry and attribute.

A further topic is Video-based Point Cloud Compression (V-PCC)—ISO/IEC 23090-5. The generic mechanism of V3C may be used by applications targeting volumetric content. One of such application is video-based point cloud compression (ISO/IEC 20390-5). V-PCC enables volumetric video coding for application in which a scene is represented by point cloud. V-PCC uses the patch data unit concept from V3C and for each patch assigns one of 6 (18) pre-defined orthogonal camera views for reprojection.

V-PCC is the only profile so far to support multi-map coding. In V-PCC, maps can be encoded with prediction between the maps. This is signaled by vps_map_absolute_coding_enabled_flag[j][i] syntax element. When this syntax element is equal to 1 (one), it indicates that the geometry map with index i for the atlas with atlas ID j is coded without any form of map prediction. When vps_map_absolute_coding_enabled_flag[j][i] is equal to 0 (zero) indicates that the geometry map with index i for the atlas with atlas ID j is first predicted from another, earlier coded, map prior to coding. If vps_map_absolute_coding_enabled_flag[j][i] is not present, its value shall be inferred to be equal to 1 (one). In V-PCC maps are used to store multiple layers of surface data, resulting in denser point clouds.

A further topic concerns MPEG Immersive Video (MIV)—ISO/IEC 23090-12. Another application of V3C is MPEG immersive video (ISO/IEC 23090-12). MIV enables volumetric video coding for applications in which a scene is recorded with multiple RGB (D) (red, green, blue, and optionally depth) cameras with overlapping fields of view (FoVs). One example setup is a linear array of cameras pointing towards a scene. This multi-scopic view of the scene allows a 3D reconstruction and therefore 6DoF (degrees of freedom)/3DoF+ consumption.

MIV uses the patch data unit concept from V3C and extends the concept by allowing use of application specific camera views for reprojection. This is in contrast to V-PCC, which uses pre-defined 6 or 18 orthogonal camera views for reprojection. Additionally, MIV introduces additional occupancy packing modes and other improvements to V3C base syntax. One such example is support for multiple atlases, for example when there is too much information to pack everything in a single video frame. It also adds support for common atlas data, which contains information that is shared between all atlases. This is particularly useful for storing camera details of the input camera models, which are frequently shared between different atlases.

Video-based dynamic mesh coding (V-DMC)—ISO/IEC 23090-29-is described now. V-DMC (ISO/IEC 23090-29) is another application form of V3C that aims on integration of mesh compression into the V3C family of standards. The standard is under development and at CD (committee draft) stage (MDS23318_WG07_N00744).

The technology is based on multiresolution mesh analysis and coding. This approach includes the following:
1) Generating a base-mesh that is a simplified (low resolution) mesh approximation of the original mesh, called base-mesh (this is done for all frames of the dynamic mesh sequence);
2) Performing several mesh subdivision iterative steps (e.g., each triangle is converted into four triangles by connecting the triangle edge midpoints on the generated base mesh, generating other approximation meshes).
3) Defining displacement vectors, also named error vectors, for each vertex of each mesh approximation. Each approximation can be seen as level of details (LoDs) of the original mesh. The role of displacement is to add small-scale geometric details by moving the vertices of triangles along a vector provided by a displacement function.
4) For each subdivision level by adding the displacement vectors to the subdivided mesh vertices generates the best approximation of the original mesh at that resolution, given the base-mesh and prior subdivision levels.
5) The displacement vectors may undergo a lazy wavelet transform prior to compression.
6) The attribute map of the original mesh is transferred to the deformed mesh at the highest resolution (i.e., subdivision level) such that texture coordinates are obtained for the deformed mesh and a new attribute map is generated.

The V-DMC encoder generates compressed bitstreams, which later on are packed in V3C units and create V3C bitstream by concatenating V3C units:
1) A sub-bitstream with the encoded base-mesh using a mesh codec.
2) A sub-bitstream with the displacement vectors:
a) packed in an 2D frame and encoded using a video codec or image codec, or
b) arithmetic encoded as defined in Annex J of WD ISO/IEC 23090-29, MDS23318_WG07_N00744A sub-bitstream with the attribute map encoded using a video codec.
3) A sub-bitstream (atlas) that contains all metadata required to decode and reconstruct the mesh sequence based on the aforementioned sub-bitstreams. The signaling of the metadata is based on the V3C syntax and includes necessary extensions that are specific to meshes.

Base-mesh bitstream (ISO/IEC 23090-29) is introduced now. An elementary unit for the output of a base-mesh encoder (Annex H of ISO/IEC 23090-29) is a NAL (network abstraction layer) unit.

A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0 (zero).

NAL units can be categorized into Base-mesh Coding Layer (BMCL) NAL units and non-BMCL NAL units. BMCL NAL units can be coded sub-mesh NAL units. A non-BMCL NAL unit may be for example one of the following types: a base-mesh sequence parameter set, a base-mesh frame parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded bas-mesh, whereas many of the other non-BMCL NAL units are not necessary for the reconstruction of decoded sample values.

V-DMC specifications may contain a set of constraints for associating data units (e.g., NAL units) into coded base-mesh access units.

ISOBMFF (ISO base media file format, where ISO=International Organization for Standardization)—ISO/IEC 14496-12 is described now. A basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISO base media file format, a file includes media data and metadata that are encapsulated into boxes. Each box is identified by a four-character code (4CC) and starts with a header which informs about the type and size of the box.

Many files formatted according to the ISO base media file format start with a file type box, also referred to as FileTypeBox or the ftyp box. The ftyp box contains information of the brands labeling the file. The ftyp box includes one major brand indication and a list of compatible brands. The major brand identifies the most suitable file format specification to be used for parsing the file. The compatible brands indicate to which file format specifications and/or conformance points the file conforms. It is possible that a file is conformant to multiple specifications. All brands indicating compatibility to these specifications should be listed, so that a reader only understanding a subset of the compatible brands can get an indication that the file can be parsed. Compatible brands also give a permission for a file parser of a particular file format specification to process a file containing the same particular file format brand in the ftyp box. A file player may check if the ftyp box of a file comprises brands it supports, and may parse and play the file only if any file format specification supported by the file player is listed among the compatible brands.

In files conforming to the ISO base media file format, the media data may be provided in one or more instances of MediaDataBox (‘mdat’) and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they contain an elementary media stream. Other track types comprise hint tracks and timed metadata tracks.

Tracks comprise samples, such as audio or video frames, or metadata frames. For video tracks, a media sample may correspond to a coded picture or an access unit. A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. A timed metadata track may refer to samples describing referred media and/or hint samples.

The ‘trak’ box includes in its hierarchy of boxes the SampleTableBox (also known as the sample table or the sample table box). The SampleTableBox contains the SampleDescriptionBox, which gives detailed information about the coding type used, and any initialization information needed for that coding. The SampleDescriptionBox contains an entry-count and as many sample entries as the entry-count indicates. The format of sample entries is track-type specific but derive from generic classes (e.g., VisualSampleEntry, AudioSampleEntry, Volumetric VisualSampleEntry). The type of sample entry form used for derivation the track-type specific sample entry format is determined by the media handler of the track.

A TrackTypeBox may be contained in a TrackBox. The payload of TrackTypeBox has the same syntax as the payload of FileTypeBox. The content of an instance of TrackTypeBox shall be such that it would apply as the content of FileTypeBox, if all other tracks of the file were removed and only the track containing this box remained in the file.

Movie fragments may be used, for example, when recording content to ISO files, for example, in order to avoid losing data if a recording application crashes, runs out of memory space, or some other incident occurs. Without movie fragments, data loss may occur because the file format may require that all metadata, for example, a movie box, be written in one contiguous area of the file. Furthermore, when recording a file, there may not be sufficient amount of memory space to buffer a movie box for the size of the storage available, and re-computing the contents of a movie box when the movie is closed may be too slow. Moreover, movie fragments may enable simultaneous recording and playback of a file using a regular ISO file parser. Furthermore, a smaller duration of initial buffering may be required for progressive downloading, e.g., simultaneous reception and playback of a file when movie fragments are used and the initial movie box is smaller compared to a file with the same media content but structured without movie fragments.

The movie fragment feature may enable splitting the metadata, which otherwise might reside in the movie box, into multiple pieces. Each piece may correspond to a certain period of time of a track. In other words, the movie fragment feature may enable interleaving file metadata and media data. Consequently, the size of the movie box may be limited and the use cases mentioned above be realized.

In some examples, the media samples for the movie fragments may reside in an mdat box. For the metadata of the movie fragments, however, a moof box may be provided. The moof box may include the information for a certain duration of playback time that would previously have been in the moov box. The moov box may still represent a valid movie on its own, but in addition, it may include an mvex box indicating that movie fragments will follow in the same file. The movie fragments may extend the presentation that is associated to the moov box in time.

Within the movie fragment there may be a set of track fragments, including anywhere from zero to a plurality per track. The track fragments may in turn include anywhere from zero to a plurality of track runs, each of which document is a contiguous run of samples for that track (and hence are similar to chunks). Within these structures, many fields are optional and can be defaulted. The metadata that may be included in the moof box may be limited to a subset of the metadata that may be included in a moov box and may be coded differently in some cases. Details regarding the boxes that can be included in a moof box may be found from the ISOBMFF specification.

A self-contained movie fragment may be defined to include a moof box and an mdat box that are consecutive in the file order and where the mdat box contains the samples of the movie fragment (for which the moof box provides the metadata) and does not contain samples of any other movie fragment (i.e., any other moof box). A media segment may comprise one or more self-contained movie fragments. A media segment may be used for delivery, such as streaming, e.g., in MPEG-Dynamic Adaptive Streaming over Hypertext Transfer Protocol (HTTP) (MPEG-DASH).

The track reference mechanism can be used to associate tracks with each other. The TrackReferenceBox includes box(es), each of which provides a reference from the containing track to a set of other tracks. These references are labelled through the box type (i.e., the four-character code of the box) of the contained box(es). The ISO Base Media File Format contains three mechanisms for timed metadata that can be associated with particular samples: sample groups, timed metadata tracks, and sample auxiliary information. Derived specification may provide similar functionality with one or more of these three mechanisms.

TrackGroupBox, which is contained in TrackBox, enables indication of groups of tracks where each group shares a particular characteristic or the tracks within a group have a particular relationship. The box contains zero or more boxes, and the particular characteristic or the relationship is indicated by the box type of the contained boxes. The contained boxes include an identifier, which can be used to conclude the tracks belonging to the same track group. The tracks that contain the same type of a contained box within the TrackGroupBox and have the same identifier value within these contained boxes belong to the same track group. The syntax of the contained boxes may be defined through TrackGroupTypeBox as follows:

```
aligned(8) class TrackGroupTypeBox(unsigned int(32) track_group_type)
extends FullBox(track_group_type, version = 0, flags = 0)
  {
    unsigned int(32) track_group_id;
    // the remaining data may be specified
    //for a particular track_group_type
  }
```

The ISO Base Media File Format contains three mechanisms for timed metadata that can be associated with particular samples: sample groups, timed metadata tracks, and sample auxiliary information. Derived specification may provide similar functionality with one or more of these three mechanisms.

A sample grouping in the ISO base media file format and its derivatives, such as the AVC file format and the scalable video coding (SVC) file format, may be defined as an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping may have a type field to indicate the type of grouping. Sample groupings may be represented by two linked data structures: (1) a SampleToGroupBox (sbgp box) represents the assignment of samples to sample groups; and (2) a SampleGroupDescriptionBox (sgpd box) contains a sample group entry for each sample group describing the properties of the group. There may be multiple instances of the SampleToGroupBox and SampleGroupDescriptionBox based on different grouping criteria. These may be distinguished by a type field used to indicate the type of grouping. SampleToGroupBox may comprise a grouping_type_parameter field that can be used, e.g., to indicate a sub-type of the grouping.

Per-sample sample auxiliary information may be stored anywhere in the same file as the sample data itself; for self-contained media files, this is typically in a MediaDataBox or a box from a derived specification. It is stored either (a) in multiple chunks, with the number of samples per chunk, as well as the number of chunks, matching the chunking of the primary sample data or (b) in a single chunk for all the samples in a movie sample table (or a movie fragment). The Sample Auxiliary Information for all samples contained within a single chunk (or track run) is stored contiguously (similarly to sample data).

Sample Auxiliary Information, when present, is stored in the same file as the samples to which it relates as they share the same data reference (′dref) structure. However, this data may be located anywhere within this file, using auxiliary information offsets (‘saio’) to indicate the location of the data.

The restricted video (‘resv’) sample entry and mechanism has been specified for the ISOBMFF in order to handle situations where the file author requires certain actions on the player or renderer after decoding of a visual track. Players not recognizing or not capable of processing the required actions are stopped from decoding or rendering the restricted video tracks. The ‘resv’ sample entry mechanism applies to any type of video codec. A RestrictedSchemeInfoBox is present in the sample entry of ‘resv’ tracks and comprises an OriginalFormatBox, SchemeTypeBox, and SchemeInformationBox. The original sample entry type that would have been unless the ‘resv’ sample entry type were used is contained in the OriginalFormatBox. The SchemeTypeBox provides an indication which type of processing is required in the player to process the video. The SchemeInformationBox comprises further information of the required processing. The scheme type may impose requirements on the contents of the SchemeInformationBox. For example, the stereo video scheme indicated in the SchemeTypeBox indicates that when decoded frames either contain a representation of two spatially packed constituent frames that form a stereo pair (frame packing) or only one view of a stereo pair (left and right views in different tracks). StereoVideoBox may be contained in SchemeInformationBox to provide further information, e.g., on which type of frame packing arrangement has been used (e.g., side-by-side or top-bottom).

Several types of stream access points (SAPs) have been specified, including the following. SAP Type 1 corresponds to what is known in some coding schemes as a “Closed group of pictures (GOP) random access point” (in which all pictures, in decoding order, can be correctly decoded, resulting in a continuous time sequence of correctly decoded pictures with no gaps) and in addition the first picture in decoding order is also the first picture in presentation order. SAP Type 2 corresponds to what is known in some coding schemes as a “Closed GOP random access point” (in which all pictures, in decoding order, can be correctly decoded, resulting in a continuous time sequence of correctly decoded pictures with no gaps), for which the first picture in decoding order may not be the first picture in presentation order. SAP Type 3 corresponds to what is known in some coding schemes as an “Open GOP random access point”, in which there may be some pictures in decoding order that cannot be correctly decoded and have presentation times less than intra-coded picture associated with the SAP.

A stream access point (SAP) sample group as specified in ISOBMFF identifies samples as being of the indicated SAP type.

A sync sample may be defined as a sample corresponding to SAP type 1 or 2. A sync sample can be regarded as a media sample that starts a new independent sequence of samples; if decoding starts at the sync sample, the sync sample and succeeding samples in decoding order can all be correctly decoded, and the resulting set of decoded samples forms the correct presentation of the media starting at the decoded sample that has the earliest composition time. Sync samples can be indicated with the SyncSampleBox (for those samples whose metadata is present in a TrackBox) or within sample flags indicated or inferred for track fragment runs.

Files conforming to the ISOBMFF may contain any non-timed objects, referred to as items, meta items, or metadata items, in a meta box (fourCC: ‘meta’), which may also be called MetaBox. While the name of the meta box refers to metadata, items can generally contain metadata or media data. The meta box may reside at the top level of the file, within a movie box (fourCC: ‘moov’), and within a track box (fourCC: ‘trak’), but at most one meta box may occur at each of the file level, movie level, or track level. The meta box may be required to contain a ‘hdlr’ box indicating the structure or format of the ‘meta’ box contents. The meta box may list and characterize any number of items that can be referred and each one of them can be associated with a file name and are uniquely identified with the file by item identifier (item_id) which is an integer value. The metadata items may be for example stored in the ‘idat’ box of the meta box or in an ‘mdat’ box or reside in a separate file. If the metadata is located external to the file then its location may be declared by the DataInformationBox (fourCC: ‘dinf’). In the specific case that the metadata is formatted using XML syntax and is required to be stored directly in the MetaBox, the metadata may be encapsulated into either the XMLBox (fourCC: ‘xml’) or the BinaryXMLBox (fourCC: ‘bxml’). An item may be stored as a contiguous byte range, or it may be stored in several extents, each being a contiguous byte range. In other words, items may be stored fragmented into extents, e.g., to enable interleaving. An extent is a contiguous subset of the bytes of the resource; the resource can be formed by concatenating the extents.

High Efficiency Image File Format (HEIF) is a standard developed by the Moving Picture Experts Group (MPEG) for storage of images and image sequences. Among other things, the standard facilitates file encapsulation of data coded according to High Efficiency Video Coding (HEVC) standard. HEIF includes features building on top of the used ISO Base Media File Format (ISOBMFF).

The ISOBMFF structures and features are used to a large extent in the design of HEIF. The basic design for HEIF comprises that still images are stored as items and image sequences are stored as tracks.

In the context of HEIF, the following boxes may be contained within the root-level ‘meta’ box and may be used as described in the following. In HEIF, the handler value of the Handler box of the ‘meta’ box is ‘pict’. The resource (whether within the same file, or in an external file identified by a uniform resource identifier) containing the coded media data is resolved through the Data Information (‘dinf’) box, whereas the Item Location (‘iloc’) box stores the position and sizes of every item within the referenced file. The Item Reference (‘iref’) box documents relationships between items using typed referencing. If there is an item among a collection of items that is in some way to be considered the most important compared to others then this item is signaled by the Primary Item (‘pitm’) box. Apart from the boxes mentioned here, the ‘meta’ box is also flexible to include other boxes that may be necessary to describe items.

Any number of image items can be included in the same file. Given a collection images stored by using the ‘meta’ box approach, it sometimes is essential to qualify certain relationships between images. Examples of such relationships include indicating a cover image for a collection, providing thumbnail images for some or all of the images in the collection, and associating some or all of the images in a collection with auxiliary image such as an alpha plane. A cover image among the collection of images is indicated using the ‘pitm’ box. A thumbnail image or an auxiliary image is linked to the primary image item using an item reference of type ‘thmb’ or ‘auxl’, respectively.

The ItemPropertiesBox enables the association of any item with an ordered set of item properties. Item properties are small data records. The ItemPropertiesBox consists of two parts: ItemPropertyContainerBox that contains an implicitly indexed list of item properties, and one or more ItemPropertyAssociationBox(es) that associate items with item properties. Item property is formatted as a box.

A descriptive item property may be defined as an item property that describes rather than transforms the associated item. A transformative item property may be defined as an item property that transforms the reconstructed representation of the image item content.

An entity may be defined as a collective term of a track or an item. An entity group is a grouping of items, which may also group tracks. An entity group can be used instead of item references, when the grouped entities do not have clear dependency or directional reference relation. The entities in an entity group share a particular characteristic or have a particular relationship, as indicated by the grouping type.

An entity group is a grouping of items, which may also group tracks. The entities in an entity group share a particular characteristic or have a particular relationship, as indicated by the grouping type.

Entity groups are indicated in GroupsListBox. Entity groups specified in GroupsListBox of a file-level MetaBox refer to tracks or file-level items. Entity groups specified in GroupsListBox of a movie-level MetaBox refer to movie-level items. Entity groups specified in GroupsListBox of a track-level MetaBox refer to track-level items of that track.

GroupsListBox contains EntityToGroupBoxes, each specifying one entity group. The syntax of EntityToGroupBox may be specified as follows:

```
aligned(8) class EntityToGroupBox(grouping_type, version, flags)
extends FullBox(grouping_type, version, flags) {
  unsigned int(32) group_id;
  unsigned int(32) num_entities_in_group;
  for(i=0; i<num_entities_in_group; i++)
    unsigned int(32) entity_id;
  // the remaining data may be specified
  // for a particular grouping_type
}
```

entity_id is resolved to an item, when an item with item_ID equal to entity_id is present in the hierarchy level (file, movie or track) that contains the GroupsListBox, or to a track, when a track with track_ID equal to entity_id is present and the GroupsListBox is contained in the file level.

Instanced rendering/drawing is described now. In real-time computer graphics, instanced rendering is the practice of rendering multiple copies of the same mesh in a scene at once without replicating the mesh data in memory. This technique is primarily used for objects such as trees, grass, or buildings which can be represented as repeated geometry without appearing unduly repetitive. It is also frequently used for rendering particle systems efficiently as it allows transforming each mesh slightly to produce alternative visual representation of the single mesh in 3D. Furthermore, each instance can be further customized by allocating different textures for the mesh or skeletal animation pose. It is noted that instancing is supported by most of the graphics APIs (application programming interfaces) used today. Each API may have a slightly different way to septet the rendering pipeline to allow instancing.

The benefit of instanced drawing is that it does not require separate draw calls to render these instances, hence sending the instructions for rendering on the GPU (graphics processing unit) can be performed more efficiently, which avoids typical problems transferring large amount of data between CPU (central processing unit) and GPU memory. Instanced drawing/rendering is a feature on all modern computer graphics APIs (application programming interfaces).

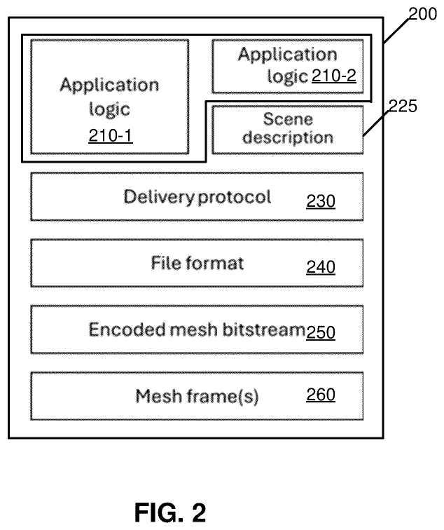

Now that technical context has been described, problems in this area are described. FIG. 2 is a block diagram illustrating a V-DMC application (e.g., also referred to as delivery) stack 200. The highest level of the stack 200 includes application logic 210-1 and 210-2 and a scene description 225. This illustrates that there is a possibility to have a stack 200 with or without scene description 225. The next layer includes delivery protocol 230, then file format 240, encoded mesh bitstream 250, and finally (at the lowest level) the mesh frame(s) 260. In 3D graphics, it is common to enable instancing of a mesh for the creation of visually rich scenes by reusing the same mesh information for multiple objects.

For current stack levels (230, 240, 250), there is no known instance-related signaling for mesh representations that is performed between encoders and decoders for video such as volumetric video. That is, instance-related processing may be performed, e.g., by application logic (210-1, 210-2) or scene description (225), but there is no instance-related signaling from an encoder to the decoder, in the delivery protocol (230), file format (240), or encoded mesh bitstream (250) levels, to let the decoder know now to apply instance-related information to mesh representations for volumetric video. The examples herein address these issues. This is described in general, including with further description of problems, then an overview and additional details are provided.

The inventors have realized that, while many of the instancing-related signaling can be handled in the higher levels of the application stack 200, such as scene description 225 or application logic 210 as seen in FIG. 2, there are scenarios where the instancing-related signaling needs to extend to the file format level of individual encoded mesh bitstreams 250 (e.g., V-DMC encoded) to allow efficient reuse of mesh data (e.g., V-DMC encoded data). For an instanced drawing, the following parameters can be used to enable how to perform instancing from a single mesh:
1) number of instances: determines how many times a mesh should be replicated;
2) animation offset (per instance): determines how an instance should be posed in the final rendering using joint- or morph-based skinned animation;
3) texture IDs (per instance): determines which textures/attributes should be used for an instance; and/or
4) transform (per instance): determines the different world positions orientations and scales for the instance.

By modifying the above parameters for each instance, it is possible to generate, for example, a representation for a herd of horses, where the visual and geometric properties of each horse can be altered. Each horse can have different size, color (via texture), orientation, position on a field and pose (via animation offset). One benefit would be reduced storage requirements for a complex scene and memory efficient rendering.

As mentioned before, for the signaling information related to instanced drawing, it may make more sense that number of instanced assets and their transformations would be signaled in the higher levels of the application stack with no consideration for the lower levels such as file format level. However, signaling of attribute (e.g., texture) variants and temporal offsets set special requirements for mesh encoded content (e.g., V-DMC). Hence, new signaling to support instanced drawing is needed from the delivery protocol and the file format levels. Consider the following problems.

Problem with texture ID: In the file format or delivery protocol, there is no signaling that would indicate that a given track or item contains alternative texture data for instancing of a mesh (e.g., V-DMC encoded).

The file format already supports signaling of different video streams as an alternative group or entity group. Using alternate_group signaling in ISOBMFF, it is possible to indicate that two video streams are alternatives of each other. The logic for using alternate_groups defines that only one track in each alternate_group may be displayed at a given time, which contradicts the intention to use different texture track variants for instanced drawing where all texture alternatives are needed for display. Entity groups signaling closely follows the logic for alternative groups, also supporting items. Thus, new mechanism for signaling instanced alternatives for drawing is needed.

Problem with animation offset: Efficient instanced animation with modern GPU APIs is achieved via skinned instancing. Skinning is a technique that allows transforming the surface mesh representation using a set of control points such as morph points or joints. As such each temporal instance uses the same mesh representation with different animation timeline and channel for the control points. This reuses the same mesh representation for each temporal variant and allows rendering multiple instances with a single draw call significantly improving the rendering performance, memory usage and CPU to GPU data transfers.

V-DMC specific use case with animation offset: Animation in V-DMC is achieved by coding independent mesh for every temporal frame and playing the frames back to achieve animation and movement like 2D image sequences. This poses a fundamental challenge for allowing efficient temporal instancing. In practice, if an application wants to allow instancing using different temporal phase of animation, the application needs to load each frame in the memory of the instanced object-basically making instanced temporal rendering useless. As such, the animation offsets will not be considered for the rest of this document outside of the specific signaling that temporal instancing should not be performed for a given object.

V-DMC submeshes can also be instanced separately for example the head of each horse in the herd could be changed while the legs would remain the same if the legs are mapped to their own submesh. In that case, a zippering postprocessing is advised to avoid cracks.

The examples herein address these and other problems. An overview is provided, then other examples are provided. An example describes how signaling information in file format and other systems enables mesh encoded objects (e.g., V-DMC encoded) to be used for efficient rendering using instanced drawing. Instanced drawing itself has many benefits such as improved rendering performance, lower memory footprint, less memory transfers between CPU and GPU systems. Examples propose signaling information that enables instanced drawing feature in the file format level and other systems. File format is used as an ingest for higher level in the application stack so that the higher levels would understand what type of instancing can be done with the encoded asset.

For the Encoder/Encapsulator, consider the following. An example of a method includes the following, which illustrated by FIG. 3, which is a block diagram of a flowchart performed by an encoder for signaling of instancing for volumetric video.
1) obtaining a mesh representation (block 310);
2) determining the mesh representation is to (e.g., can) be instanced and how to instance the mesh representation (block 320);
3) creating signaling information related to instanced drawing of a mesh representation (block 330); and
4) storing (e.g., the mesh representation and) the signaling information related to instanced drawing in or along with the mesh representation (block 340). That is, at least the signaling information would be stored, and the mesh representation may also be stored.

It is assumed that there is storage of information (such as any of the bitstreams 136, 143, 146, and 151 of FIG. 1A, and possibly including the V3C bitstream 155), and then at some point, the stored information would be communicated outside the encoder 130, toward a decoder 140. This could be almost instantaneous, e.g., in a real-time scenario such as between two users of cellular devices or VR headsets, or there could be quite a bit of delay between storage and transmission, such as when volumetric video is stored in an on-demand streaming service and transmitted only when there is a request for the volumetric video. The stored mesh representation and signaling information may be communicated via a bitstream (e.g., bitstream 101 such as a V3C bitstream 155 in an example), e.g., to a decoder/parser. Determining how the mesh representation is to be instanced can have multiple aspects. For instance, how the mesh representation is to be instanced can be up to a content creator. As another example, how the mesh representation is to be instanced can be described as how the mesh representation is performed, e.g., the number of instances of the mesh representation, and the other examples provided below.

It is noted that an encoder 130 is this context may include the following:
1) A V-DMC encoder that creates SEI messages and includes the information in one of V-DMC components.
2) An ISOBMF File Format encapsulator that could propagate the V-DMC SEI message information through file format or get instancing information from another source.
3) An SDP creator that could propagate the V-DMC SEI message information, file format or get instancing information from another source.
4) An MPD creator that could propagate the V-DMC SEI message information, file format information or get instancing information from another source.

It is noted that a corresponding decoder 140 for the encoders (1)-(4) would be able to decode the information sent by these encoders.

Additional examples for encoding/encapsulating include the following.

The mesh representation can be one or meshes. The mesh representation can be represented in an encoded V-DMC bitstream. The mesh representation can be represented in a sequence of draco encoded frames and associated attributes. Determining to use the mesh representation for instanced drawing, temporal instancing (of the instanced drawing), and alternative versions (of the instanced drawing) and their parameters may be performed by the content author, and provided as input to an encapsulator (e.g., a file encapsulator) that forms an encapsulated version of the mesh representation. As to the parameters, these are for both the temporal instancing and the alternative versions. In terms of an encoder, the content author can indicate to the encoder that the mesh representation for the instanced drawing, the temporal instancing (of the instanced drawing), and the alternative versions (of the instanced drawings) (e.g., and their parameters) should be used. The encoder receives the indication from the content author and, in response to the indication, uses the mesh representation for the instanced drawing, the temporal instancing (of the instanced drawing), and the alternative versions (of the instanced drawings).

The signaling information may contain one or more of the following:
1) information indicating if the mesh representation could be rendered using instanced drawing;
2) information indicating if temporal instancing could be used for the mesh representation;
3) information indicating alternative instanced versions of the mesh representation;
4) information providing attribute/texture information per instance of the instanced versions of the mesh representation;
5) information provides attribute/texture group that is to (e.g., can) be used by instances of the instanced versions of the mesh representation; and/or
6) information indicating position, orientation, scaling per instance of the instanced versions of the mesh representation.

At least the signaling information of (3), (4), (5), and/or (6) can used to describe how to instance the mesh representation for an encoder and indicate, for a decoder, at least how to act upon the interpreted signaling information by instancing the mesh representation.

The signaling information may be stored in a file format. The file format may be ISOBMFF-based.

The signaling information may be stored as SEI messages, as in the following examples:
1) the SEI message can be in atlas bitstream of V-DMC;
2) the SEI message can be in the base-mesh bitstream of V-DMC; and/or
3) the SEI message can be in video bitstream of V-DMC.

The signaling information may be stored in a transport manifest, such as the following:
1) the transport manifest can be a DASH manifest for HTTP delivery; and/or
2) the transport manifest is a session description protocol (SDP) transport manifest for real-time delivery.

As is known, a transport manifest includes a text-based document that includes details about a media stream. For instance, a DASH transport manifest is a text file describing the way to fetch information. An SDP transport manifest is also a text file describing the way to establish sessions.

For the Decoder/Parser part, consider the following. An example of a method includes the following example in FIG. 4, which is a block diagram of a flowchart performed by a decoder for signaling of instancing for volumetric video. The method includes the following:
1) obtaining the mesh representation and the signaling information related to instanced drawing in or along the mesh representation (block 410);
2) interpreting the signaling information for the instanced drawing (block 420); and
3) acting upon the interpreted signaling information (block 430).

As an example, block 420 could interpret the signaling information of (1)-(6) above. Then, block 430 would implement the interpreted signaling information.

Now that an overview has been provided, more details are provided, wherein descriptions are focused on for storing the instancing related signaling information in ISOBMFF-based file format, DASH manifest, and SDP-file. The file may be used as an ingest for higher levels of the application stack to provide information how the contents of the file can be used for efficient rendering using instanced drawing.

Firstly, a set of information is defined that can be used convey instancing related information for a mesh object. Later, example structures are provided and explanation is provided of signaling how this could look like for V-DMC encoded content in the various systems. It is noted that all syntax and semantics hereunder should be considered as examples, not definitive. The examples should consider all or a subset of the example data. General structures are now described.

For indicating that a mesh object is to (e.g., can) be instanced, one may consider a structure like Instancing as described below.

| aligned (8) struct Instancing { | |
|---|---|
| bool(1) | can_be_instanced; |
| bool(1) | can_be_temporally_instanced; |
| uint(6) | reserved; |
| uint(16) | instance_count; |
| for(i = 0; i < instance_count; i++){ | |
| float(32)[3] | scaling[i] |
| float(32)[3] | orientation[i]; |
| float(32)[3] | position[i]; |

```
    uint(16) attribute_count;
    for(a = 0; a < attribute_count; a++){
```

| | |
|---|---|
| uint(8) | attribute_type[i][a]; |
| uint(16) | texture_id[i][a]; |

}
}

can_be_instanced indicates if the contents of the track should be used for instanced drawing.

can_be_temporally_instanced indicates if the contents of the track can be used for temporal instancing.

instance_count indicates a number of unique variations of the instancing.

It is noted that the number is generated using the content of file format (e.g., number of unique attribute tracks the track).

scaling provides information how to scale an instance in x, y and z dimension.

orientation describes how the instance should be rotated as a quaternion with x, y and z component. W-component of the quaternion is calculated based on the three other components.

position describes how the instance should be translated in x, y and z dimension.

attribute_count indicates number of attributes associated with a given instance

attribute_type indicates the type of the attribute with id=texture_id. This can be useful for adapting material details for the mesh representation.

texture_id indicates the id of a texture/attribute.

File format is described now. In case of ISOBMFF (ISO/IEC 14496-12) the structure would extend a FullBox structure or a Box structure defined in ISO/IEC 14496-12.

V-DMC bitstream encapsulation is expected to reflect the fundamental design of V3C encapsulation in ISOBMFF as described in the 23090-10. New V-DMC specific sub-bitstreams will be added such as the displacement and base-mesh sub-bitstream. Atlas track is expected to continue as the main entry point for tying the different V-DMC component bitstreams together. However, there are scenarios where base-mesh sub-bitstream could be considered as the main entry point to the content.

There are alternative designs for providing instancing information, including one or more of the following:
1) Instancing signaling is added in the sample entry of the main atlas track for V-DMC encoded bitstreams.
2) Instancing signaling is added as a new track group entry in the track group description box.
3) Instancing signaling is added as a new track group.
4) Instancing signaling is added as a new entity group.
5) Other methods.

In one embodiment, a new box is added in the V3CAtlasSampleEntry that contains the instancing related signaling. The syntax of the V3CAtlasSampleEntry could be as follows:

```
aligned(8) class V3CAtlasSampleEntry( ) extends
VolumetricVisualSampleEntry (type) {
  // type is ‘v3c1’, ‘v3cg’, ‘v3cb’, ‘v3a1’, or ‘v3ag’
  V3CConfigurationBox config;
  V3CUnitHeaderBox unit_header;
  V3CUnitHeaderBox cad_unit_header; // optional
  Instancing instancing_info; // optional
}
```

instancing_info contains the structure Instancing as describer earlier in the document.

In another embodiment, a new track group entry box is added in track group description box to indicate the that the mesh content in the file can be used for instanced drawing. The syntax of the new track group entry box could be as follows:
Box Type: ‘inst’
Container: TrackGroupDescriptionBox
Mandatory: No
Quantity: Zero or More

```
aligned(8) class InstancingTrackGroupEntryBox extends
TrackGroupEntryBox(‘inst’) {
  // track_group_id is inherited from TrackGroupEntryBox
  Instancing instancing_info;
}
```

instancing_info provides the information for instancing for tracks belonging to track_group_id.

It is noted that the 4CC ‘inst’ is used as an example, but any 4CC could be used.

In one embodiment, in case of an ISOBMFF file format, the texture_id texture ID could correspond to track ID or item ID containing the texture for the instance. In another embodiment, in case of an ISOBMFF file format, the texture_id texture ID could correspond to track group entry ID, track group ID, track ID, entity to group ID, or item ID that contains textures that can be use during the instancing.

In one embodiment, a track group Instance AttributeTrackGroupBox is defined to associate tracks that are alternative to each other and can be used during instanced drawing.
Box Type: ‘iatg’
Container: TrackGroupBox
Mandatory: No
Quantity: Zero or more

```
aligned(8) class InstanceAttributeTrackGroupBox extends
TrackGroupBox(‘iatg’) {
  // track_group_id is inherited from TrackGroupBox
  unsigned int(1) default_attribute;
}
```

default_attribute equal to 1 indicates the default attribute if instancing is not used. Only one track in belonging to ‘iatg’ group should be defined as default.

In one embodiment, a new box is defined to associate tracks/items that are alternative to each other and can be used during instanced drawing.
Box Types: ‘iatg’
Container: Groups List Box (‘grpl’)
Mandatory: No
Quantity: Zero or more
Syntax may include the following.

aligned(8) class ObjectSwitchAlternativesBox extends
EntityToGroupBox(‘iatg’) {
unsigned int(1) default_attribute;
}

default_attribute equal to 1 indicates the default attribute if instancing is not used. Only one track in belonging to iatg group should be defined as default.

In another embodiment, special type of track references may be added to indicate alternative attribute (e.g., color) tracks for instancing. For example, a client could decide on its own which attribute track to use for each instancing of the mesh. In another embodiment, a new track group type box is defined. The instancing information would need to be replicated for every track belonging to the group.

In another embodiment, the functionality described by the above embodiments is also applicable to items.

DASH Manifest is described now. In one embodiment, the instancing information may be bundled in DASH manifest to allow a DASH receiver to smartly select different adaptation sets for instanced rendering. The association with the adaptation set may be done by adding explicit new parameters as indicated in Instance-structure or by adding a new attribute that consists of the same fields.

The semantics for instancing_info.texture_id will be different for DASH manifest, where the texture_id could indicate the adaptation set IDs or Representation set IDs of the different variants.

Real-time streaming SDP is described now. In another embodiment, instancing information may be added in the Session Description protocol to allow identifying different media streams for streaming.

The semantics for instancing_info.texture_id will be different for SDP-file, where the texture_id would indicate the MID-values of the different texture/attribute variants.

SEI is described now. In another embodiment, instancing information may be contained in the SEI messages to allow identifying different media streams for streaming.

The semantics for instancing_info.texture_id will be different for SEI messages, where the texture_id could correspond to V-DMC attribute index, base mesh attribute index, or layer of video containing different texture/attribute variants

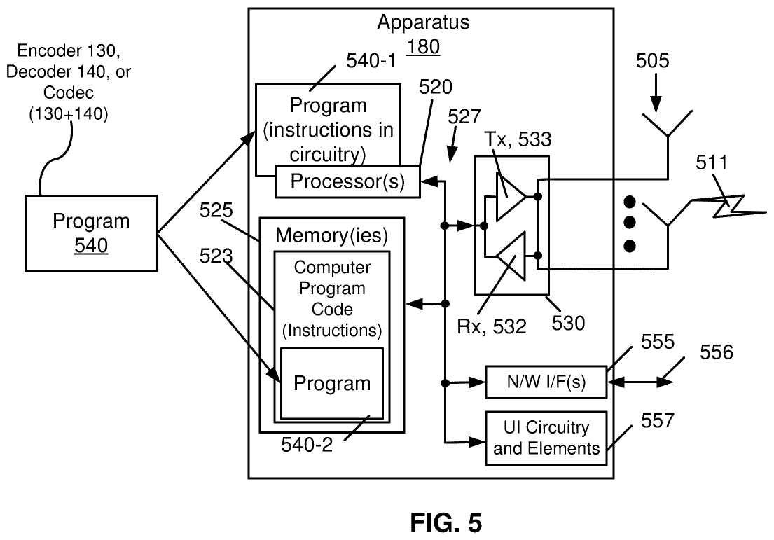

Turning to FIG. 5, this figure is an example of a block diagram of an apparatus 180 suitable for implementing any of the encoders or decoders described herein. The apparatus 180 includes circuitry comprising one or more processors 520, one or more memories 525, one or more transceivers 530, one or more network (N/W) interface(s) (I/F(s)) 555 and user interface (UI) circuitry and elements 557, interconnected through one or more buses 527. Depending on implementation, some apparatus may not have all of the circuitry. For example, an apparatus 180 might not have UI circuitry and elements 557. An apparatus may have additional circuitry, not described here. FIG. 5 is presented merely as an example.

Each of the one or more transceivers 530 includes a receiver, Rx, 532 and a transmitter, Tx, 533. The one or more buses 527 may be address, data, and/or control buses, and may include any interconnection mechanism, such as a series of lines on a motherboard or integrated circuit, fiber optics or other optical communication equipment, and the like. The one or more transceivers 530 are connected to one or more antennas 505, and may communicate using wireless link 511, which could implement any number of wireless communication interfaces such as Wi-Fi, cellular, or satellite.

The one or more memories 525 include computer program code 523. The apparatus 180 includes a program 540, comprising one of or both parts 540-1 and/or 540-2. The program 540 may implement an encoder 130, a decoder 140, or a codec (130+140), which implements both encoding and decoding. The program itself may be implemented in a number of ways. The program 540 may be implemented in circuitry as program 540-1, such as being implemented as part of the one or more processors 520, and contains instructions implemented in circuitry. The program 540-1 may be implemented also as an integrated circuit or through other circuitry such as a programmable gate array. In another example, the program 540 may be implemented as program 540-2, which is implemented as computer program code (having corresponding instructions) 523 and is executed by the one or more processors 520. For instance, the one or more memories 525 store instructions that, when executed by the one or more processors 520, cause the apparatus 180 to perform one or more of the operations as described herein.

The network interface(s) (N/W I/F(s)) 555 are wired interfaces communicating using link(s) 556, which could be fiber optic or other wired interfaces. The apparatus 180 could include only wireless transceiver(s) 530, only N/W I/Fs 555, or both wireless transceiver(s) 530 and N/W I/Fs 555.

The apparatus 180 may or may not include UI circuitry and elements 557. These could include a display such as a touchscreen, speakers, or interface elements such as for headsets. For instance, an apparatus 180 of a smartphone would typically include at least a touchscreen and speakers. The UI circuitry and elements 557 may also include circuitry to communicate with external UI elements (not shown) such as displays, keyboards, mice, headsets, and the like.

The computer readable memories 525 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The processor(s) 520 may be of any type suitable to the local technical environment, and may include one or more of general-purpose computers, special purpose computers, microprocessors, digital signal processors (DSPs) and processors based on a multi-core processor architecture, as non-limiting examples. The processor(s) 520 control the apparatus 180 to perform the operations as described herein. The processor(s) 520 may execute instructions, including microcode, but are not implemented solely in software.

Without in any way limiting the scope, interpretation, or application of the claims appearing below, a technical effect and/or advantage of one or more of the example embodiments disclosed herein is full stack information that enables ingest of instancing related signaling from low level to higher level. A content producer can provide instancing information with the raw representation of the assets that is propagated though the processing pipeline and can reach the end consumer. Another technical effect and/or advantage of one or more of the example embodiments disclosed herein is that utilizing instancing signaling an amount of data necessary to exchange assets between content producer and end user can be further minimized.

The following are additional examples.

Example 1. A method, comprising: obtaining a mesh representation of volumetric video; determining the mesh representation is to be instanced and how to instance the mesh representation; creating signaling information related to instanced drawing of the mesh representation; and storing the signaling information related to the instanced drawing in or along with the mesh representation.

Example 2. The method according to example 1, further comprising communicating, to a decoder, the stored signaling information.

Example 3. The method according to any of examples 1 or 2, wherein the mesh representation comprises in one or more meshes.

Example 4. The method according to any of examples 1 to 3, wherein the mesh representation is represented in an encoded video-based dynamic mesh coding (V-DMC) bitstream.

Example 5. The method according to any of examples 1 to 3, wherein the mesh representation is represented in a sequence of draco encoded frames and associated attributes.

Example 6. The method according to any of examples 1 to 5, wherein the mesh representation for the instanced drawing, temporal instancing of the instanced drawing, and alternative versions of the instance drawing and parameters for the temporal instancing and the alternative versions are provided as input to an encapsulator that forms an encapsulated version of the mesh representation.

Example 7. The method according to example 6, performed by an encoder, wherein the encoder receives indication from a content author that the encoder should perform the using the mesh representation for the instanced drawing, for temporal instancing of the instanced drawing, and for alternative versions of the instance drawing, and, in response to the indication, the encoder uses the mesh representation for the instanced drawing, for temporal instancing of the instanced drawing, and for alternative versions of the instanced drawing.

Example 8. The method according to any of examples 1 to 7, wherein the signaling information comprises one or more of the following: (1) information indicating whether the mesh representation is to be rendered using the instanced drawing; (2) information indicating whether temporal instancing is to be used for the mesh representation; (3) information indicating alternative instanced versions of the mesh representation; (4) information providing attribute/texture information per instance of instanced versions of the mesh representation; (5) information provides attribute/texture group that is to be used by instances of instanced versions of the mesh representation; or (6) information indicating position, orientation, scaling per instance of instanced versions of the mesh representation.

Example 9. The method according to example 8, wherein at least (3), (4), (5), and (6) indicate at least how to instance the mesh representation.

Example 10. The method according to any of examples 1 to 9, wherein the signaling information is stored in a file format.

Example 11. The method according to example 10, wherein the file format is ISOBMFF-based, where ISOBFF is ISO base media file format, and where ISO is International Organization for Standardization.

Example 12. The method according to any of examples 1 to 9, wherein the signaling information is stored as one or more supplemental enhancement information (SEI) messages, and the one or more SEI messages are stored in one or more of the following: an atlas bitstream of video-based dynamic mesh coding (V-DMC); a base-mesh bitstream of V-DMC; or a video bitstream of V-DMC.

Example 13. The method according to any of examples 1 to 9, wherein the signaling information is stored in a transport manifest, wherein: the transport manifest is a Dynamic Adaptive Streaming over Hypertext Transfer Protocol (HTTP) (DASH) manifest for HTTP delivery; or the transport manifest is a session description protocol (SDP) transport manifest for real-time delivery.

Example 14. A method, comprising: obtaining a mesh representation of volumetric video from a bitstream and signaling information related to instanced drawing in or along the mesh representation in the bitstream; interpreting the signaling information; and acting upon the interpreted signaling information.

Example 15. The method according to example 14, wherein the mesh representation comprises one or meshes.

Example 16. The method according to any of examples 14 to 15, wherein the mesh representation is represented in an encoded video-based dynamic mesh coding (V-DMC) bitstream.

Example 17. The method according to any of examples 14 to 15, wherein the mesh representation is represented in a sequence of draco encoded frames and associated attributes.

Example 18. The method according to any of examples 14 to 17, wherein the signaling information comprises one or more of the following: (1) information indicating whether the mesh representation is to be rendered using the instanced drawing; (2) information indicating whether temporal instancing is to be used for the mesh representation; (3) information indicating alternative instanced versions of the mesh representation; (4) information providing attribute/texture information per instance of instanced versions of the mesh representation; (5) information provides attribute/texture group that is to be used by instances of instanced versions of the mesh representation; or (6) information indicating position, orientation, scaling per instance of instanced versions of the mesh representation.

Example 19. The method according to example 18, wherein at least (3), (4), (5), and (6) indicate at least how to act upon the interpreted signaling information by instancing the mesh representation.

Example 20. The method according to any of examples 14 to 19, wherein the signaling information is stored in a file format.

Example 21. The method according to example 20, wherein the file format is ISOBMFF-based, where ISOBFF is ISO base media file format, and where ISO is International Organization for Standardization.

Example 22. The method according to any of examples 14 to 19, wherein the signaling information is stored as one or more supplemental enhancement information (SEI) messages, and the one or more SEI messages are stored in one or more of the following: an atlas bitstream of video-based dynamic mesh coding (V-DMC); a base-mesh bitstream of V-DMC; or a video bitstream of V-DMC.

Example 23. The method according to any of examples 14 to 19, wherein the signaling information is stored in a transport manifest, wherein: the transport manifest is a Dynamic Adaptive Streaming over Hypertext Transfer Protocol (HTTP) (DASH) manifest for HTTP delivery; or the transport manifest is a session description protocol (SDP) transport manifest for real-time delivery.

Example 24. An apparatus, comprising means for: obtaining a mesh representation of volumetric video; determining the mesh representation is to be instanced and how to instance the mesh representation; creating signaling information related to instanced drawing of the mesh representation; and storing the signaling information related to the instanced drawing in or along with the mesh representation.

Example 25. The apparatus according to example 24, wherein the means are further configured for communicating, to a decoder, the stored signaling information.

Example 26. The apparatus according to any of examples 24 or 25, wherein the mesh representation comprises in one or more meshes.

Example 27. The apparatus according to any of examples 24 to 26, wherein the mesh representation is represented in an encoded video-based dynamic mesh coding (V-DMC) bitstream.

Example 28. The apparatus according to any of examples 24 to 26, wherein the mesh representation is represented in a sequence of draco encoded frames and associated attributes.

Example 29. The apparatus according to any of examples 24 to 28, wherein the mesh representation for the instanced drawing, temporal instancing of the instanced drawing, and alternative versions of the instance drawing and parameters for the temporal instancing and the alternative versions are provided as input to an encapsulator that forms an encapsulated version of the mesh representation.

Example 30. The apparatus according to example 29, comprising an encoder, wherein the encoder receives indication from a content author that the encoder should perform the using the mesh representation for the instanced drawing, for temporal instancing of the instanced drawing, and for alternative versions of the instance drawing, and, in response to the indication, the encoder uses the mesh representation for the instanced drawing, for temporal instancing of the instanced drawing, and for alternative versions of the instanced drawing.

Example 31. The apparatus according to any of examples 24 to 30, wherein the signaling information comprises one or more of the following: (1) information indicating whether the mesh representation is to be rendered using the instanced drawing; (2) information indicating whether temporal instancing is to be used for the mesh representation; (3) information indicating alternative instanced versions of the mesh representation; (4) information providing attribute/texture information per instance of instanced versions of the mesh representation; (5) information provides attribute/texture group that is to be used by instances of instanced versions of the mesh representation; or (6) information indicating position, orientation, scaling per instance of instanced versions of the mesh representation.

Example 32. The apparatus according to example 31, wherein at least (3), (4), (5), and (6) indicate at least how to instance the mesh representation.

Example 33. The apparatus according to any of examples 24 to 32, wherein the signaling information is stored in a file format.

Example 34. The apparatus according to example 33, wherein the file format is ISOBMFF-based, where ISOBFF is ISO base media file format, and where ISO is International Organization for Standardization.

Example 35. The apparatus according to any of examples 24 to 32, wherein the signaling information is stored as one or more supplemental enhancement information (SEI) messages, and the one or more SEI messages are stored in one or more of the following: an atlas bitstream of video-based dynamic mesh coding (V-DMC); a base-mesh bitstream of V-DMC; or a video bitstream of V-DMC.

Example 36. The apparatus according to any of examples 24 to 32, wherein the signaling information is stored in a transport manifest, wherein: the transport manifest is a Dynamic Adaptive Streaming over Hypertext Transfer Protocol (HTTP) (DASH) manifest for HTTP delivery; or the transport manifest is a session description protocol (SDP) transport manifest for real-time delivery.

Example 37. An apparatus, comprising means for: obtaining a mesh representation of volumetric video from a bitstream and signaling information related to instanced drawing in or along the mesh representation in the bitstream; interpreting the signaling information; and acting upon the interpreted signaling information.

Example 38. The apparatus according to example 37, wherein the mesh representation comprises one or meshes.

Example 39. The apparatus according to any of examples 37 to 38, wherein the mesh representation is represented in an encoded video-based dynamic mesh coding (V-DMC) bitstream.

Example 40. The apparatus according to any of examples 37 to 38, wherein the mesh representation is represented in a sequence of draco encoded frames and associated attributes.

Example 41. The apparatus according to any of examples 37 to 40, wherein the signaling information comprises one or more of the following: (1) information indicating whether the mesh representation is to be rendered using the instanced drawing; (2) information indicating whether temporal instancing is to be used for the mesh representation; (3) information indicating alternative instanced versions of the mesh representation; (4) information providing attribute/texture information per instance of instanced versions of the mesh representation; (5) information provides attribute/texture group that is to be used by instances of instanced versions of the mesh representation; or (6) information indicating position, orientation, scaling per instance of instanced versions of the mesh representation.

Example 42. The apparatus according to example 41, wherein at least (3), (4), (5), and (6) indicate at least how to act upon the interpreted signaling information by instancing the mesh representation.

Example 43. The apparatus according to any of examples 37 to 42, wherein the signaling information is stored in a file format.

Example 44. The apparatus according to example 43, wherein the file format is ISOBMFF-based, where ISOBFF is ISO base media file format, and where ISO is International Organization for Standardization.

Example 45. The apparatus according to any of examples 37 to 42, wherein the signaling information is stored as one or more supplemental enhancement information (SEI) messages, and the one or more SEI messages are stored in one or more of the following: an atlas bitstream of video-based dynamic mesh coding (V-DMC); a base-mesh bitstream of V-DMC; or a video bitstream of V-DMC.

Example 46. The apparatus according to any of examples 37 to 42, wherein the signaling information is stored in a transport manifest, wherein: the transport manifest is a Dynamic Adaptive Streaming over Hypertext Transfer Protocol (HTTP) (DASH) manifest for HTTP delivery; or the transport manifest is a session description protocol (SDP) transport manifest for real-time delivery.

Example 47. An apparatus, comprising: one or more processors; and one or more memories storing instructions that, when executed by the one or more processors, cause the apparatus at least to perform: obtaining a mesh representation of volumetric video; determining the mesh representation is to be instanced and how to instance the mesh representation; creating signaling information related to instanced drawing of the mesh representation; and storing the signaling information related to the instanced drawing in or along with the mesh representation.

Example 48. The apparatus according to example 47, wherein the one or more memories further store instructions that, when executed by the one or more processors, cause the apparatus at least to perform communicating, to a decoder, the stored signaling information.

Example 49. The apparatus according to any of examples 47 or 48, wherein the mesh representation comprises in one or more meshes.

Example 50. The apparatus according to any of examples 47 to 49, wherein the mesh representation is represented in an encoded video-based dynamic mesh coding (V-DMC) bitstream.

Example 51. The apparatus according to any of examples 47 to 49, wherein the mesh representation is represented in a sequence of draco encoded frames and associated attributes.

Example 52. The apparatus according to any of examples 47 to 51, wherein the mesh representation for the instanced drawing, temporal instancing of the instanced drawing, and alternative versions of the instance drawing and parameters for the temporal instancing and the alternative versions are provided as input to an encapsulator that forms an encapsulated version of the mesh representation.

Example 53. The apparatus according to example 52, comprising an encoder, wherein the encoder receives indication from a content author that the encoder should perform the using the mesh representation for the instanced drawing, for temporal instancing of the instanced drawing, and for alternative versions of the instance drawing, and, in response to the indication, the encoder uses the mesh representation for the instanced drawing, for temporal instancing of the instanced drawing, and for alternative versions of the instanced drawing.

Example 54. The apparatus according to any of examples 47 to 53, wherein the signaling information comprises one or more of the following: (1) information indicating whether the mesh representation is to be rendered using the instanced drawing; (2) information indicating whether temporal instancing is to be used for the mesh representation; (3) information indicating alternative instanced versions of the mesh representation; (4) information providing attribute/texture information per instance of instanced versions of the mesh representation; (5) information provides attribute/texture group that is to be used by instances of instanced versions of the mesh representation; or (6) information indicating position, orientation, scaling per instance of instanced versions of the mesh representation.

Example 55. The apparatus according to example 54, wherein at least (3), (4), (5), and (6) indicate at least how to instance the mesh representation.

Example 56. The apparatus according to any of examples 47 to 55, wherein the signaling information is stored in a file format.

Example 57. The apparatus according to example 56, wherein the file format is ISOBMFF-based, where ISOBFF is ISO base media file format, and where ISO is International Organization for Standardization.

Example 58. The apparatus according to any of examples 47 to 55, wherein the signaling information is stored as one or more supplemental enhancement information (SEI) messages, and the one or more SEI messages are stored in one or more of the following: an atlas bitstream of video-based dynamic mesh coding (V-DMC); a base-mesh bitstream of V-DMC; or a video bitstream of V-DMC.

Example 59. The apparatus according to any of examples 47 to 55, wherein the signaling information is stored in a transport manifest, wherein: the transport manifest is a Dynamic Adaptive Streaming over Hypertext Transfer Protocol (HTTP) (DASH) manifest for HTTP delivery; or the transport manifest is a session description protocol (SDP) transport manifest for real-time delivery.

Example 60. An apparatus, comprising: one or more processors; and one or more memories storing instructions that, when executed by the one or more processors, cause the apparatus at least to perform: obtaining a mesh representation of volumetric video from a bitstream and signaling information related to instanced drawing in or along the mesh representation in the bitstream; interpreting the signaling information; and acting upon the interpreted signaling information.

Example 61. The apparatus according to example 60, wherein the mesh representation comprises one or meshes.

Example 62. The apparatus according to any of examples 60 to 63, wherein the mesh representation is represented in an encoded video-based dynamic mesh coding (V-DMC) bitstream.

Example 63. The apparatus according to any of examples 60 to 63, wherein the mesh representation is represented in a sequence of draco encoded frames and associated attributes.

Example 64. The apparatus according to any of examples 60 to 65, wherein the signaling information comprises one or more of the following: (1) information indicating whether the mesh representation is to be rendered using the instanced drawing; (2) information indicating whether temporal instancing is to be used for the mesh representation; (3) information indicating alternative instanced versions of the mesh representation; (4) information providing attribute/texture information per instance of instanced versions of the mesh representation; (5) information provides attribute/texture group that is to be used by instances of instanced versions of the mesh representation; or (6) information indicating position, orientation, scaling per instance of instanced versions of the mesh representation.

Example 65. The apparatus according to example 66, wherein at least (3), (4), (5), and (6) indicate at least how to act upon the interpreted signaling information by instancing the mesh representation.

Example 66. The apparatus according to any of examples 60 to 67, wherein the signaling information is stored in a file format.

Example 67. The apparatus according to example 68, wherein the file format is ISOBMFF-based, where ISOBFF is ISO base media file format, and where ISO is International Organization for Standardization.

Example 68. The apparatus according to any of examples 60 to 67, wherein the signaling information is stored as one or more supplemental enhancement information (SEI) messages, and the one or more SEI messages are stored in one or more of the following: an atlas bitstream of video-based dynamic mesh coding (V-DMC); a base-mesh bitstream of V-DMC; or a video bitstream of V-DMC.

Example 69. The apparatus according to any of examples 60 to 67, wherein the signaling information is stored in a transport manifest, wherein: the transport manifest is a Dynamic Adaptive Streaming over Hypertext Transfer Protocol (HTTP) (DASH) manifest for HTTP delivery; or the transport manifest is a session description protocol (SDP) transport manifest for real-time delivery.

Example 70. A computer program, comprising instructions which, when the program is executed by an apparatus, cause the apparatus to carry out the methods of any of examples 1 to 23.

Example 71. The computer program according to example 70, wherein the computer program is a computer program product comprising a computer-readable medium bearing the instructions embodied therein for use with the apparatus.

Example 72. The computer program according to example 70, wherein the computer program is directly loadable into an internal memory of the apparatus.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) (including digital signal processor(s)) with software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 5. A computer-readable medium may comprise a computer-readable storage medium (e.g., memories 525 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
2D two-dimensional
three-dimensional 3D
4CC or fourCC
four-character code
application programming interface
augmented reality
API
AR
AVC advanced video coding
BMCL Base-mesh Coding Layer
CPU central processing unit
CVS coded V3C sequences
DASH Dynamic Adaptive Streaming over Hypertext Transfer Protocol (HTTP)
DoF degrees of freedom
GOP group of pictures
GPU graphics processing unit
HEIF High Efficiency Image File Format
HEVC High Efficiency Video Coding
HTTP hyper-text transfer protocol
ID or id identification
ISOBMFF ISO base media file format, where ISO=International Organization for Standardization
FoV field of view
LoD level of detail
MIV MPEG immersive video, where MPEG is moving picture experts group
MPEG-DASH MPEG-Dynamic Adaptive Streaming over Hypertext Transfer Protocol (HTTP)
MPD MPEG-DASH
MR mixed reality
NAL network abstraction layer
RBSP raw byte sequence payload
SAP stream access point
SCV scalable video coding
SDP session description protocol
SEI supplemental enhancement information
V3C Visual Volumetric Video-based Coding
V-DMC Video-based dynamic mesh coding
V-PCC Video-based point cloud compression
VPS V3C parameter set
VR virtual reality
WD working draft
WG working group

What is claimed is:

1. A method, comprising: obtaining a mesh representation of volumetric video from a bitstream and signaling information related to instanced drawing in or along the mesh representation in the bitstream; interpreting the signaling information; and acting upon the interpreted signaling information.

2. The method according to claim 1, wherein the mesh representation comprises one or meshes.

3. The method according to claim 1, wherein the mesh representation is represented in an encoded video-based dynamic mesh coding (V-DMC) bitstream.

4. The method according to claim 1, wherein the signaling information comprises one or more of the following: (1) information indicating whether the mesh representation is to be rendered using the instanced drawing; (2) information indicating whether temporal instancing is to be used for the mesh representation; (3) information indicating alternative instanced versions of the mesh representation; (4) information providing attribute/texture information per instance of instanced versions of the mesh representation; (5) information providing attribute/texture group that is to be used by instances of instanced versions of the mesh representation; or (6) information indicating position, orientation, scaling per instance of instanced versions of the mesh representation.

5. The method according to claim 4, wherein at least (3), (4), (5), and (6) indicate at least how to act upon the interpreted signaling information by instancing the mesh representation.

6. An apparatus, comprising: one or more processors; and one or more memories storing instructions that, when executed by the one or more processors, cause the apparatus at least to perform: obtaining a mesh representation of volumetric video; determining the mesh representation is to be instanced and how to instance the mesh representation;
creating signaling information related to instanced drawing of the mesh representation; and storing the signaling information related to the instanced drawing in or along with the mesh representation.

7. The apparatus according to claim 6, wherein the mesh representation is represented in an encoded video-based dynamic mesh coding (V-DMC) bitstream.

8. The apparatus according to claim 6, wherein the mesh representation for the instanced drawing, temporal instancing of the instanced drawing, and alternative versions of the instance drawing and parameters for the temporal instancing and the alternative versions are provided as input to an encapsulator that forms an encapsulated version of the mesh representation.

9. The apparatus according to claim 8, comprising an encoder, wherein the encoder receives indication from a content author that the encoder should perform the using the mesh representation for the instanced drawing, for temporal instancing of the instanced drawing, and for alternative versions of the instance drawing, and, in response to the indication, the encoder uses the mesh representation for the instanced drawing, for temporal instancing of the instanced drawing, and for alternative versions of the instanced drawing.

10. The apparatus according to claim 6, wherein the signaling information comprises one or more of the following: (1) information indicating whether the mesh representation is to be rendered using the instanced drawing; (2) information indicating whether temporal instancing is to be used for the mesh representation; (3) information indicating alternative instanced versions of the mesh representation; (4) information providing attribute/texture information per instance of instanced versions of the mesh representation; (5) information providing attribute/texture group that is to be used by instances of instanced versions of the mesh representation; or (6) information indicating position, orientation, scaling per instance of instanced versions of the mesh representation.

11. An apparatus, comprising: one or more processors; and one or more memories storing instructions that, when executed by the one or more processors, cause the apparatus at least to perform: obtaining a mesh representation of volumetric video from a bitstream and signaling information related to instanced drawing in or along the mesh representation in the bitstream; interpreting the signaling information; and acting upon the interpreted signaling information.

12. The apparatus according to claim 11, wherein the mesh representation comprises one or meshes.

13. The apparatus according to claim 11, wherein the mesh representation is represented in an encoded video-based dynamic mesh coding (V-DMC) bitstream.

14. The apparatus according to claim 11, wherein the mesh representation is represented in a sequence of draco encoded frames and associated attributes.

15. The apparatus according to claim 11, wherein the signaling information comprises one or more of the following: (1) information indicating whether the mesh representation is to be rendered using the instanced drawing; (2) information indicating whether temporal instancing is to be used for the mesh representation; (3) information indicating alternative instanced versions of the mesh representation; (4) information providing attribute/texture information per instance of instanced versions of the mesh representation; (5) information providing attribute/texture group that is to be used by instances of instanced versions of the mesh representation; or (6) information indicating position, orientation, scaling per instance of instanced versions of the mesh representation.

16. The apparatus according to claim 15, wherein at least (3), (4), (5), and (6) indicate at least how to act upon the interpreted signaling information by instancing the mesh representation.

17. The apparatus according to claim 11, wherein the signaling information is stored in a file format.

18. The apparatus according to claim 17, wherein the file format is ISOBMFF-based, where ISOBFF is ISO base media file format, and where ISO is International Organization for Standardization.

19. The apparatus according to claim 11, wherein the signaling information is stored as one or more supplemental enhancement information (SEI) messages, and the one or more SEI messages are stored in one or more of the following: an atlas bitstream of video-based dynamic mesh coding (V-DMC); a base-mesh bitstream of V-DMC; or a video bitstream of V-DMC.

20. The apparatus according to claim 11, wherein the signaling information is stored in a transport manifest, wherein: the transport manifest is a Dynamic Adaptive Streaming over Hypertext Transfer Protocol (HTTP) (DASH) manifest for HTTP delivery; or the transport manifest is a session description protocol (SDP) transport manifest for real-time delivery.
